(19) United States
(12) Patent Application Publication
(10) Pub. No.: US 2021/0112323 A1
(43) Pub. Date: Apr. 15, 2021

(54) MULTI-CHIP MODULES FOR WIRELESS AUDIO DEVICES

(71) Applicant: PRA AUDIO SYSTEMS, INC., Lawrenceville, GA (US)

(72) Inventor: K. Paul Raley, Lawrenceville, GA (US)

(21) Appl. No.: 17/065,791

(22) Filed: Oct. 8, 2020

Related U.S. Application Data
(60) Provisional application No. 62/913,535, filed on Oct. 10, 2019.

(51) Int. Cl. H04R 1/02; H04R 1/04; H04B 7/155; H04R 3/12; H04R 5/04

(52) U.S. Cl. CPC H04R 1/028; H04R 1/04; H04R 5/04; H04R 3/12; H04B 7/155

(57) ABSTRACT

Multi-chip modules are designed for use in transmitters and receivers used in high-fidelity wireless digital audio networks. The modules may be incorporated into a variety of devices, including microphones, transmitters, instruments, speakers, amplifiers, audio boards, and similar devices. Multi-chip modules incorporate features to accommodate a plurality of audio input formats and wireless network types, including a proprietary, wireless audio network. A boot loader, in conjunction with user-selectable pins or switches, allows a multi-chip module to be configured at startup based on code that is stored in non-volatile memory.

### CROSS-REFERENCE TO RELATED APPLICATIONS

This application claims priority to provisional application 62/913,535, filed Oct. 10, 2019, and titled “Integrated Circuits for Wireless Audio Devices,” the disclosure of which is hereby incorporated by reference in its entirety.

### TECHNICAL FIELD

This disclosure relates to wireless digital audio transmission. More specifically, this disclosure relates to configurable multi-chip modules for use in wireless digital audio devices, such as transmitters, receivers, microphones, speakers and musical instruments.

### BRIEF SUMMARY

The present disclosure relates to technologies associated with the wireless digital transmission of audio signals. According to some embodiments, integrated circuits, or multi-chip modules, can comprise a variety of components useful to receive, process, and transmit audio signals.

According to further embodiments, an audio integrated circuit or multi-chip module is configurable so that a single device type may be configured by a user. The configuration may be pin-selectable, where the configuration allows the user to determine whether the audio device is configured as a transmitter or receiver, and whether it transmits or receives the left, right, or both channels of a stereo signal.

According to further embodiments, an audio integrated circuit or multi-chip module may be configured to receive input in a variety of formats or from a variety of sources, and to send output signals in a variety of formats to a variety of receivers. Audio formats may include Inter-IC Sound (I2S), USB audio, analog audio, or other formats.

Various implementations described in the present disclosure can comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations can be realized and obtained by means of the systems, methods, and features particularly pointed out in the appended claims. These and other features will become more fully apparent from the following description and appended claims, or can be learned by the practice of such exemplary implementations as set forth hereinafter.

### BRIEF DESCRIPTION OF THE DRAWINGS

In the following Detailed Description, references are made to the accompanying drawings, which form a part hereof, and show, by way of illustration, specific embodiments or examples. The features and components of the following figures are illustrated to emphasize the general principles of the present disclosure. The drawings herein are not drawn to scale. Like numerals represent like elements throughout the several figures.

FIG. 1 is a block diagram of an audio multi-chip module for receiving I2S audio and transmitting it wirelessly via an antenna port, or vice versa.

FIG. 2 is a block diagram of a configurable version of the audio multi-chip module of FIG. 1, where the multi-chip module is configured using pin select logic, a boot loader, and non-volatile memory.

FIG. 3 is a block diagram of an audio multi-chip module for receiving I2S audio and transmitting it via one of two wireless networks, or vice versa.

FIG. 4 is a block diagram of a configurable version of the audio multi-chip module of FIG. 3, where the multi-chip module is configured using pin select logic, a boot loader, and non-volatile memory.

FIG. 5 is a block diagram of an audio multi-chip module for receiving I2S audio and transmitting it wirelessly via one of two antenna ports, or vice versa.

FIG. 6 is a block diagram of a configurable version of the audio multi-chip module of FIG. 5, where the multi-chip module is configured using pin select logic, a boot loader, and non-volatile memory.

FIG. 7 is a block diagram of an audio multi-chip module for receiving analog audio or I2S audio and transmitting it wirelessly via an antenna port, or vice versa.

FIG. 8 is a block diagram of a configurable version of the audio multi-chip module of FIG. 7, where the multi-chip module is configured using pin select logic, a boot loader, and non-volatile memory.

FIG. 9 is a block diagram of an audio multi-chip module for receiving analog audio or I2S audio and transmitting it via one of two wireless networks, or vice versa.

FIG. 10 is a block diagram of a configurable version of the audio multi-chip module of FIG. 9, where the multi-chip module is configured using pin select logic, a boot loader, and non-volatile memory.

FIG. 11 is a block diagram of an audio multi-chip module for receiving analog audio or I2S audio and transmitting it wirelessly via one of two antenna ports, or vice versa.

FIG. 12 is a block diagram of a configurable version of the audio multi-chip module of FIG. 11, where the multi-chip module is configured using pin select logic, a boot loader, and non-volatile memory.

FIG. 13 is a block diagram of an audio multi-chip module for receiving a USB audio signal and transmitting it wirelessly via an antenna port.

FIG. 14 is a block diagram of a configurable version of the audio multi-chip module of FIG. 13, where the multi-chip module is configured using pin select logic, a boot loader, and non-volatile memory.

### DETAILED DESCRIPTION

The present disclosure can be understood more readily by reference to the following detailed description, examples, drawings, and claims, and their previous and following descriptions. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

The following detailed description is directed to technologies associated with the wireless digital transmission of audio signals.

Wireless audio is very popular in many different settings. For example, wireless microphones are used by singers, actors, performers, and presenters in live performances and presentations. Musicians often use wireless transmitters (instead of cables) to transmit audio from their instruments to a sound board, peddle board, amplifier, computer, or other equipment. Many of these systems are analog, and experience problems common to analog audio systems, such as interference, static, distortion, limited range, and other problems.

Digital transmission of audio signals avoids some of the problems associated with the analog transmission of audio signals. Examples of digital audio transmission include Bluetooth-enabled speakers, automotive audio systems, and other systems that are designed to play audio that is streamed from smartphones, tablets, and other digital devices over a Bluetooth connection. However, Bluetooth and other common digital systems also include features that limit their suitability for use with audio, and with high fidelity music in particular.

In most cases, digital audio is compressed in order to reduce the amount of data that must be transmitted or stored. Popular compression techniques include mp 3 and Advanced Audio Coding (AAC). Both of these formats are lossy digital compression schemes and the process of compressing the digital signal, transmitting it, and then decompressing it results in audio that is not 100% true to the original audio source. Although it would be desirable to transmit uncompressed digital data, some digital systems, including Bluetooth systems, require that audio signals be compressed in some manner due to limitations on the data rates in those systems. Most people find this loss of fidelity to be undesirable, especially musicians and other audiophiles who demand accurate reproduction of music produced by their instruments or played on their audio systems.

Some versions of Wi-Fi (IEEE 802.11) have theoretical data rates in the hundreds of megabits per second, which is much faster than Bluetooth and could transport uncompressed digital audio signals. However, Wi-Fi, and other data-oriented transmission schemes introduce variable latencies. They also employ separate routers and require fairly complicated processes for setting up the network and adding devices to the network. They are also susceptible to interference from other devices, includes appliances, HVAC systems, etc.

Additional considerations include the range and the number of connections that are supported by the system. Bluetooth is typically reliable only up to about 30 feet and only connects to one speaker or headset at a time. The range of Wi-Fi depends on a variety of factors, but is typically in the range of about 120 feet. Although many devices can connect to a Wi-Fi network, inconsistent latency characteristics render Wi-Fi less than ideal for connecting multiple speakers to a single audio source.

The ubiquity of systems and devices that wirelessly transmit audio using current technologies (such as Bluetooth, Wi-Fi, and analog systems) have made them very popular when compared to wired speakers, earbuds, and headphones, despite the problems discussed above.

In light of the popularity of wireless audio transmission and the shortcomings associated with current technologies and products, it is desirable to provide a wireless audio technology that is designed to deliver a consistent 24-bit High Definition (HD) audio signal with a range of up to 500 feet over its own dedicated, secure, easy-to-set-up, proprietary wireless network. This will eliminate the need for routers, extenders, separate applications, complicated set-ups, long network keys, pairing (and re-pairing) while also operating in an extremely secure way.

In addition, in light of the desirability of incorporating HD digital wireless audio transmitters and receivers into many devices, such as speakers, microphones, instrument pick-ups, smartphones, etc., it would be advantageous to eliminate the need for most discrete components and embody this technology in a single integrated circuit or multi-chip module. In addition to advantages in terms of size, this also provides advantages such as lower power requirements, single voltage power supplies, reduced system noise, and improved radio frequency (RF) efficiency.

Generally speaking, an integrated circuit is a set of electronic circuits or components that are fabricated on a single, small piece of silicon or other semiconductor material. A silicon wafer contains hundreds or thousands of dies. Each die is a single copy of the circuit and may be as small as a few millimeters square. The dies are tested, separated, and packaged in a variety of ways that make them useful in electronic products.

In some cases, it is advantageous to combine the functions available in separate integrated circuits into a single integrated circuit. A multi-chip module is an electronic assembly where multiple integrated circuits, semiconductor dies, or other discrete components are integrated, usually onto a unifying substrate, so that it can be treated as if it were a larger integrated circuit. This type of device may also be referred to as a System-in-a-Package (SIP).

Those skilled in the art will appreciate that an end-user device or finished product that is capable of wirelessly transmitting and receiving high-fidelity audio signals may require a variety of inputs and outputs and a variety of features or functions.

For example, a product or device may receive or provide audio in a variety of formats. If the device receives or provides analog audio, it will need not only analog audio inputs and outputs, but an audio codec suitable for converting analog audio signals into digital audio signals, and vice versa. A suitable audio codec can be the Texas Instruments TLV320AIC3101 stereo audio codec or similar device. If the device is to receive or provide digital audio outputs (such as USB or Inter-IC (I2C) audio), it will not need an audio codec, but will need appropriate inputs and outputs.

A wireless digital audio device may also employ circuitry capable of converting or modulating the digital signal into a radio frequency (RF) signal suitable for transmission by the transmitter, or for demodulating the signal at the receiver. This circuitry may be embodied in a system on a chip (SoC) and is often referred to as a radio SoC or RF SoC. Such an integrated circuit or SoC can also provide other features, such as frequency hopping, forward error correction, buffering, retransmission, etc. These features may be implemented, incorporated, or employed in such as was as to form a proprietary, wireless audio network. A suitable radio SoC can be the Texas Instruments CC8520/21/30/31 SoC for wireless digital audio streaming or similar device. The CC85XX family of devices offers different options regarding the number of channels supported by the device, and whether the device supports USB digital audio or I2S digital audio.

Depending on the output power of the radio SoC that is used and the desired output capabilities of the device, a wireless digital audio device may also employ an RF range extender in order to amplify the RF signal and increase the effective range of the device. A suitable RF range extender can be the Texas Instruments CC2592 2.4 GHz range extender or similar device.

A Wireless microcontroller unit (MCU) (also referred to as a wireless module) may also be employed if the device is to be capable of connecting to legacy wireless networks, such as Wi-Fi or Bluetooth, in addition to the proprietary, wireless audio network supported by the radio SoC and RF range extender. A suitable wireless module can be the Texas Instruments CC3200 SimpleLink single-chip wireless MCU or similar device.

Those skilled in the art will appreciate that a benefit of providing multi-chip modules that combine or incorporate the desired features (as opposed to employing separate, discrete components that implement each feature) is that transmitters and receivers capable of transmitting and receiving high-fidelity wireless audio signals may be smaller, less expensive, and more suitable for incorporation into audio products such as microphones, speakers, etc. Replacing discrete components with a multi-chip module offers additional advantages, including a single voltage power supply, improved RF efficiency, reduced system noise, reduced passive component count, and reduced system noise floor. These features can be increasingly important as governments or regulatory bodies impose stricter regulations on RF products.

More specifically, incorporating SoCs or integrated circuits into a multi-chip module provides several advantages over the present practice of incorporating multiple SoCs or integrated circuits on a standard, surface mount printed circuit board. For example, when a radio SoC and an RF range extender are used together on a conventional printed circuit board, there is a performance degradation that results from the relatively large distance between power supply pins on separate devices. This can result in noise pulses appearing on the power rails when the RF components enter transmission mode. This problem can be addressed in multi-chip modules of the present disclosure by minimizing the routing distance between the radio SoC and RF range extender. Reducing the length of the power supply runs greatly enhances the ability to supply sufficient on-demand current to the devices without sagging the power supply rail. In addition, the use of on-chip capacitance, in close proximity to the power leads of the radio SoC and the RF range extender, controls parasitic anomalies at the power supply leads. The effective values of these passive devices range from about 1 microfarad to 10 microfarads.

Incorporating the radio SoC and the RF range extender into a multi-chip module also enhances the integrity of the RF signals sourced by the radio SoC. In some embodiments, the radio SoC provides two RF output signals, including a positive differential RF signal and a negative differential RF signal. These signals may be in the 2.4 GHz range and in a conventional printed circuit board layout are greatly impacted by multiple connection transitions and undesired exposure to multiple noise sources. In a printed circuit board design, the differential RF signals originate inside the radio SoC and are wire bonded to the radio SoC's package pins. These pins are soldered to the printed circuit board. Two traces (with limited current capacity) are routed to the pins on the RF range extender. These traces may be on the order of 10 mm long. The pins are wire bonded to the silicon internal to the RF range extender. By placing the radio SoC and the RF range extender on a single substrate inside a multi-chip module, the number of connection transitions is significantly reduced. For example, the differential RF signals are wire bonded to the RF range extender, and the length of these connections may be less than 1 mm. This greatly reduces the losses that may be experienced in the 2.4 GHz band and in other very high frequency and ultra-high frequency bands and eliminates exposure to other parasitic signals present on the printed circuit board. It also reduces or eliminates the effects on other devices that can result from transmitting this strong 2.4 GHz signal across the printed circuit board. These features are paramount to the operation of these full spectrum, mixed signal designs, which incorporate and process both analog and digital signals and provide a portal between the analog and digital worlds.

Other issues may also be addressed by this design. For example, there may be a specific noise anomaly around 400 Hz with certain radio SoCs and RF range extenders. A multi-chip module according to the present disclosure may incorporate various components, such as inductors, at the power supply leads to control this noise.

An additional feature of the present disclosure is the use of pin-selectable logic, a boot loader, and non-volatile memory to allow devices to be user-configurable. By way of example, if a device has three two-position switches, they could be used to allow the user to choose up to eight different operating modes. The following table illustrates how three two-position switches can be set to configure the device to transmit right channel, receive right channel, transmit left channel, receive left channel, transmit both channels, or receive both channels.

| Switch 1: | Switch 2: | Switch 3: | |
|---|---|---|---|
| Xmit/Rcv | Right | Left | Mode |
| 0 | 0 | 0 | N/A |
| 0 | 0 | 1 | Receive left channel |
| 0 | 1 | 0 | Receive right channel |
| 0 | 1 | 1 | Receive both channels |
| 1 | 0 | 0 | N/A |
| 1 | 0 | 1 | Transmit left channel |
| 1 | 1 | 0 | Transmit right channel |
| 1 | 1 | 1 | Transmit both channels |

When the device boots up, it can read the switch settings and use those to determine which code the boot loader should read from the non-volatile memory. By providing this type of configurability, a manufacturer can inventory fewer different products since the same multi-chip module can be used for any of these modes or configurations.

Turning now to the drawings figures, several embodiments of the present disclosure will be described. In some aspects, the present disclosure features multi-chip modules that incorporate the features and functionality discussed above in various combinations in order to meet various design criteria and product requirements.

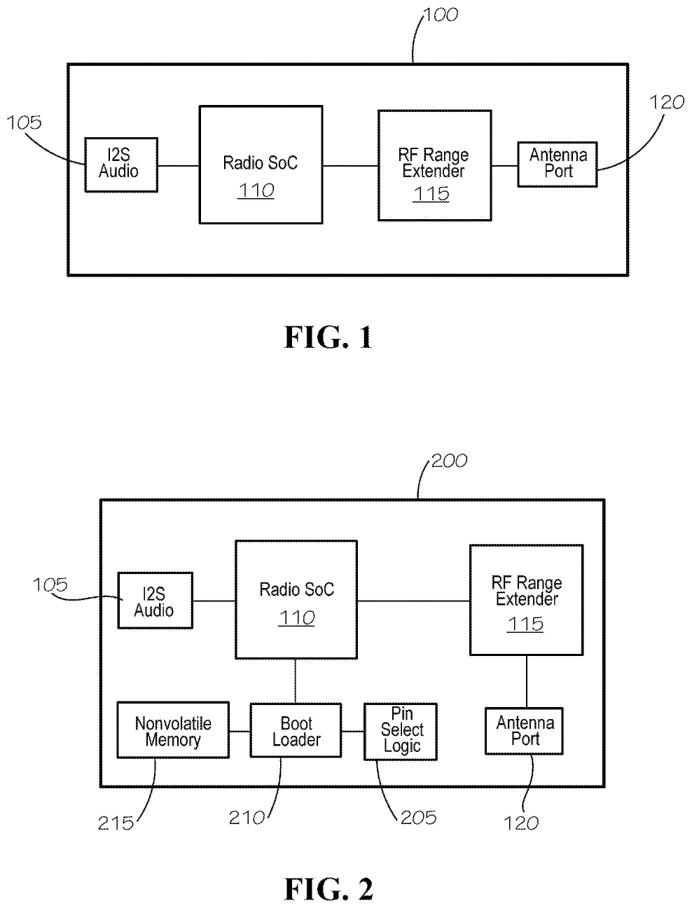

FIG. 1 is a block diagram of an audio multi-chip module 100 for receiving I2S digital audio and transmitting it wirelessly via an antenna port (e.g., a 50 ohm antenna port), or vice versa. The multi-chip module incorporates an I2S audio port 105, a radio SoC 110, and RF range extender 115, and an antenna port 120. When configured in transmit mode, an I2S digital audio signal would be input at the I2S audio port 105, processed by the radio SoC 110, processed by the RF range extender 115, and the resulting RF signal provided to the antenna port 120. When configured in receive mode, an RF signal would be received at the antenna port 120, processed by the range extender 115, processed by the radio SoC 110, and the resulting I2S digital audio signal provided to the I2S audio port 105.

FIG. 2 is a block diagram of a configurable version 200 of the audio multi-chip module of FIG. 1, where the multi-chip module 200 is configured using pin select logic 205, a boot loader 210, and non-volatile memory 215 similar to that described above. Once configured at start-up via the boot loader, the multi-chip module 200 would operate as described in conjunction with the multi-chip module 100 FIG. 1.

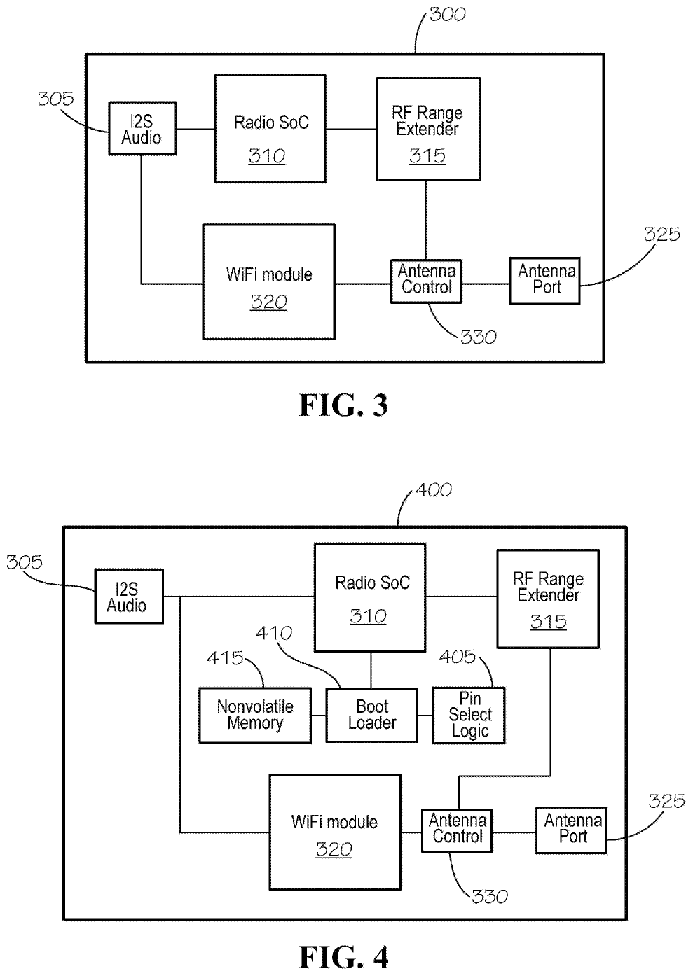

FIG. 3 is a block diagram of an audio multi-chip module 300 for receiving I2S digital audio and transmitting it via one of two wireless networks, or vice versa. The multi-chip module incorporates an I2S digital audio port 305, a radio SoC 310, an RF range extender 315, a wireless module 320, and an antenna port 325. An antenna control module 330 is used to determine which signal path has access to the antenna port. When configured in transmit mode, an I2S digital audio signal would be input at the I2S digital audio port 305. If the high-fidelity wireless audio mode is selected, the signal will be processed by the radio SoC 310 and the RF range extender 315, and the resulting proprietary, wireless audio signal provided to the antenna port 325 via the antenna control module 330. Alternatively, if the device is configured to connect wirelessly via Wi-Fi or other legacy network, the I2S signal will be processed by the wireless module 320 and provided to the antenna port 325 via the antenna control module 330. When configured in receive mode, the signals would travel the reverse path.

FIG. 4 is a block diagram of a configurable version 400 of the audio multi-chip module of FIG. 3, where the multi-chip module 400 is configured using pin select logic 405, a boot loader 410, and non-volatile memory 415 similar to that described above. Once configured at start-up via the boot loader, the multi-chip module 400 would operate as described in conjunction with the multi-chip module 300 of FIG. 3.

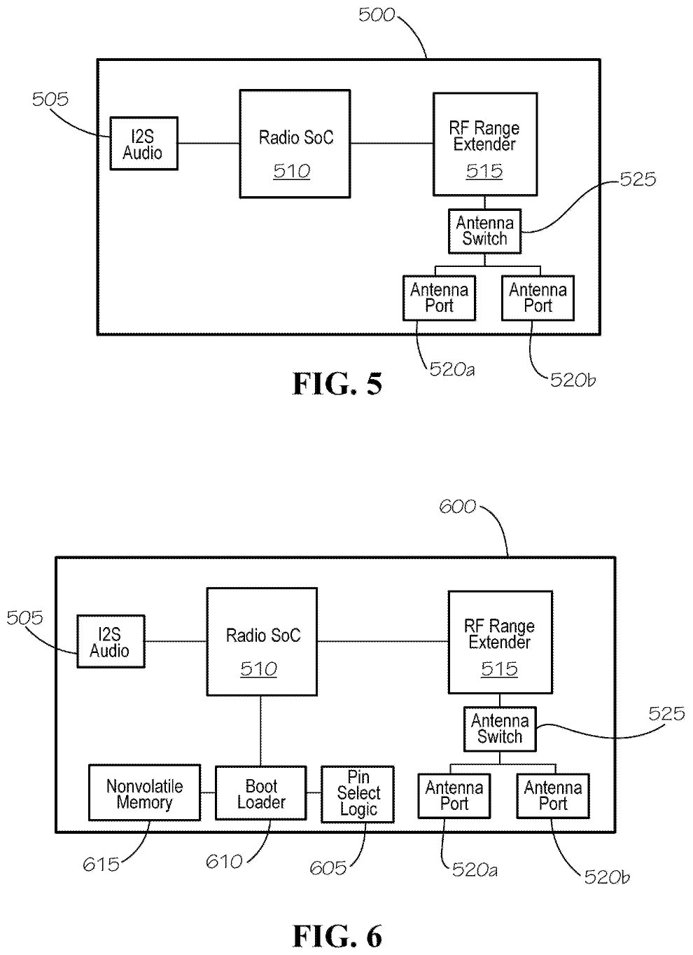

FIG. 5 is a block diagram of an audio multi-chip module 500 for receiving I2S digital audio and transmitting it wirelessly via one of two antenna ports, or vice versa. The multi-chip module incorporates an I2S digital audio port 505, a radio SoC 510, and RF range extender 515, and multiple antenna ports 520a, 520b. When configured in transmit mode, an I2S digital audio signal would be input at the I2S audio port 505, processed by the radio SoC 510, processed by the RF range extender 515, and the resulting RF signal provided to one of the antenna ports 520a, 520b via the antenna switch 525. When configured in receive mode, an RF signal would be received at one of the antenna ports 520a, 520b, processed by the range extender 515, processed by the radio SoC 510, and the resulting I2S digital audio signal provided to the I2S audio port 505.

FIG. 6 is a block diagram of a configurable version 600 of the audio multi-chip module of FIG. 5, where the multi-chip module 600 is configured using pin select logic 605, a boot loader 610, and non-volatile memory 615 similar to that described above. Once configured at start-up via the boot loader, the multi-chip module 600 would operate as described in conjunction with the multi-chip module 500 of FIG. 5.

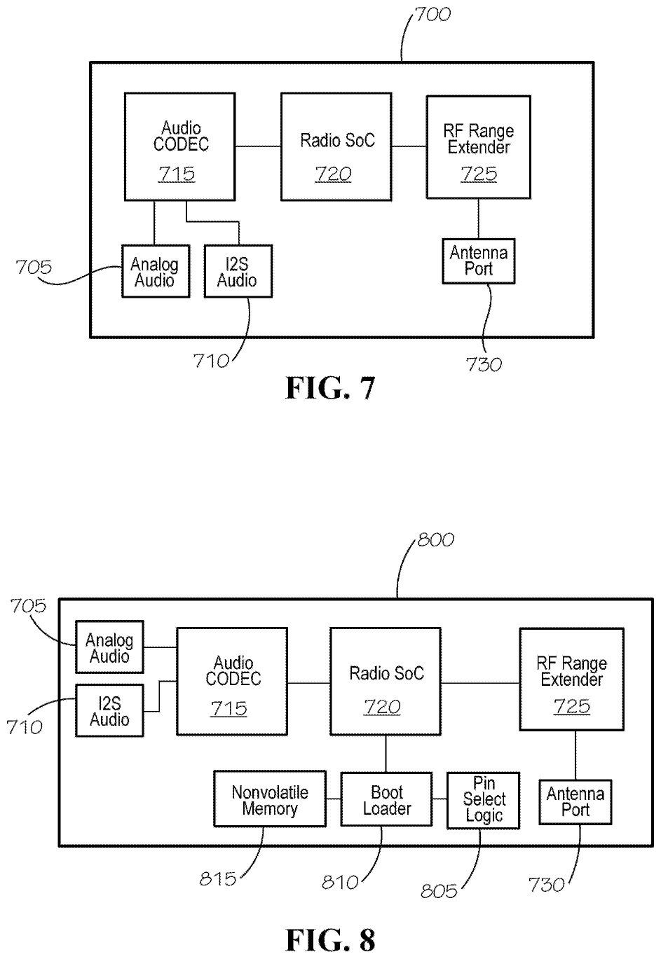

FIG. 7 is a block diagram of an audio multi-chip module 700 for receiving analog audio or I2S digital audio and transmitting it wirelessly via an antenna port, or vice versa. The multi-chip module 700 includes an analog audio input 705 and an I2S digital audio input 710, along with an audio codec 715 for encoding or decoding the audio signal. The multi-chip module 700 also includes a radio SoC 720, an RF range extender 725, and an antenna port 730. When configured in transmit mode, an analog audio signal or I2S digital audio signal would be input at the analog audio port 705 or I2S digital audio port 710, respectively. An analog audio signal is encoded by the audio codec 715. The digital audio signal is processed by the radio SoC 720, processed by the RF range extender 725, and the resulting RF signal provided to the antenna port 730. When configured in receive mode, an RF signal would be received at the antenna port 730, processed by the range extender 725, processed by the radio SoC 720, and either provided to the I2S digital audio output 710 as a digital signal, or provided to the analog audio output 705 as an analog signal after being processed by the audio codec 715.

FIG. 8 is a block diagram of a configurable version 800 of the audio multi-chip module of FIG. 7, where the multi-chip module 800 is configured using pin select logic 805, a boot loader 810, and non-volatile memory 815 similar to that described above. Once configured at start-up via the boot loader, the multi-chip module 800 would operate as described in conjunction with the multi-chip module 700 of FIG. 7.

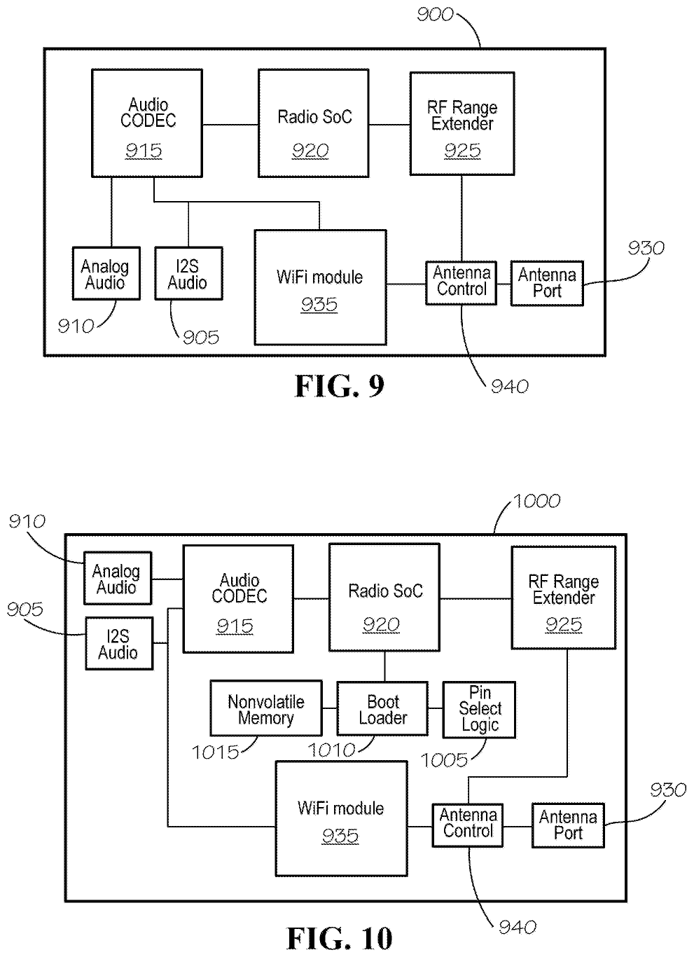

FIG. 9 is a block diagram of an audio multi-chip module 900 for receiving analog audio or I2S digital audio and transmitting it via one of two wireless networks, or vice versa. Its operation and optional functionality are similar to the combined functions discussed in conjunction with FIGS. 3 and 7 above. Thus, the multi-chip module 900 may receive digital or analog audio via I2S digital audio port 905 or analog audio port 910, which is then converted to digital audio signal by the audio codec 915. If the digital audio is to be transmitted over a proprietary, wireless audio network, the signal will pass through and be processed by the radio SoC 920 and RF range extender 925 before being provided to the antenna port 930. If the digital audio is to be transmitted over Wi-Fi, the digital audio signal will pass through the Wi-Fi module 935 before being provided to the antenna port 930 via antenna control module 940.

FIG. 10 is a block diagram of a configurable version 1000 of the audio multi-chip module of FIG. 9, where the multi-chip module 1000 is configured using pin select logic 1005, a boot loader 1010, and non-volatile memory 1015 similar to that described above. Once configured at start-up via the boot loader, the multi-chip module 1000 would operate as described in conjunction with the multi-chip module 900 of FIG. 9.

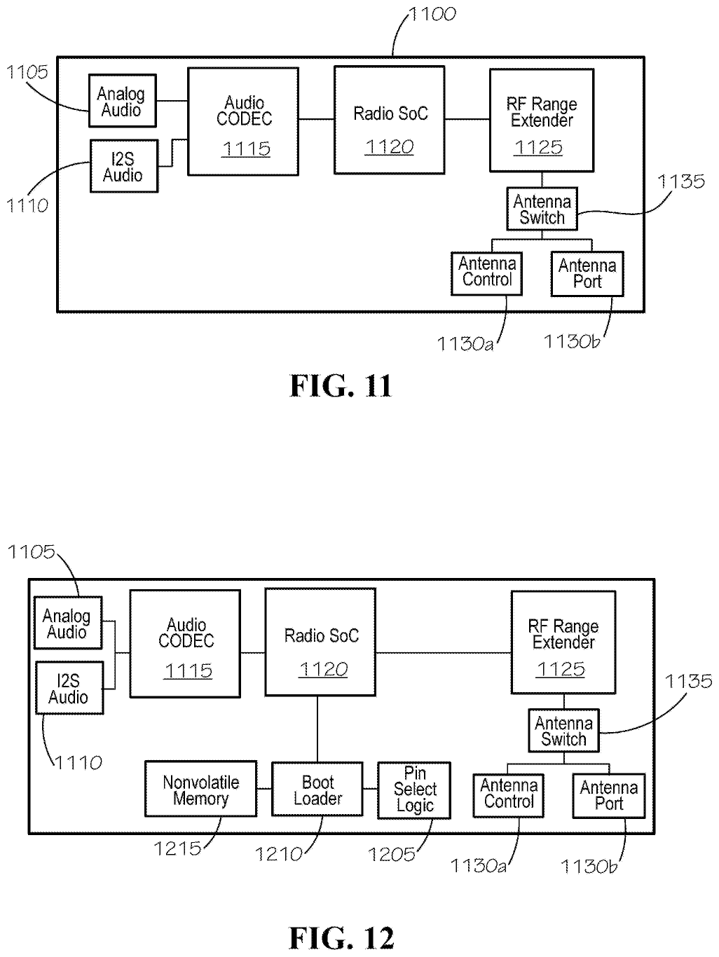

FIG. 11 is a block diagram of an audio multi-chip module 1100 for receiving analog audio or I2S digital audio and transmitting it wirelessly via one of two antenna ports, or vice versa. Its operation and optional functionality is similar to the combined functions discussed above in conjunction with FIGS. 5 and 7. Thus, the multi-chip module 1100 may receive analog audio or I2S digital audio via the corresponding ports 1105, 1110, digitize an analog signal via the audio codec 1115, process the digital signal with the radio SoC 1120, process the RF signal with the RF range extender 1125, and provide the RF signal to either of two (or more) antenna ports 1130a, 1130b via the antenna switch 1135.

FIG. 12 is a block diagram of a configurable version 1200 of the audio multi-chip module of FIG. 11, where the multi-chip module is configured using pin select logic 1205, a boot loader 1210, and non-volatile memory 1215 similar to that described above. Once configured at start-up via the boot loader, the multi-chip module 1200 would operate as described in conjunction with the multi-chip module 1100 of FIG. 11.

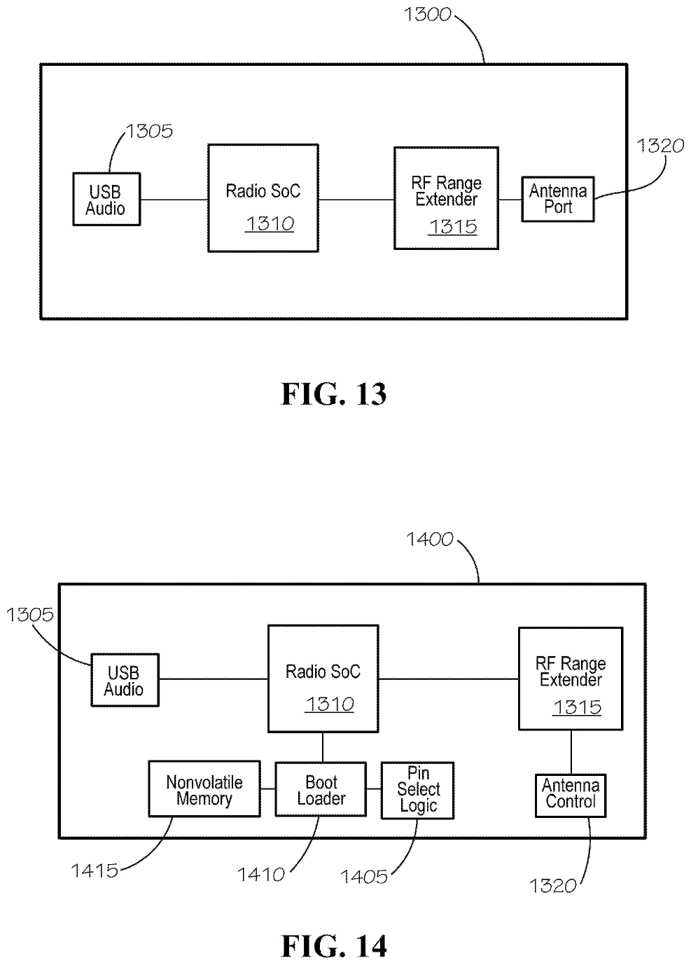

FIG. 13 is a block diagram of an audio multi-chip module 1300 for receiving a USB digital audio signal and transmitting it wirelessly via an antenna port 1320. The multi-chip module 1300 incorporates a USB audio port 1305, a radio SoC 1310, and RF range extender 1315, and an antenna port 1330. When configured in transmit mode, a USB audio signal (which is digital) would be input at the USB audio port 1305, processed by the radio SoC 1310, processed by the RF range extender 1315, and the resulting RF signal provided to the antenna port 1320. When configured in receive mode, an RF signal would be received at the antenna port 1320, processed by the RF range extender 1325, processed by the radio SoC 1310, and the resulting USB audio signal provided to the USB audio port 1305.

FIG. 14 is a block diagram of a configurable version 1400 of the audio multi-chip module of FIG. 13, where the multi-chip module 1400 is configured using pin select logic 1405, a boot loader 1410, and non-volatile memory 1415 similar to that described above. Once configured at start-up via the boot loader, the multi-chip module 1400 would operate as described in conjunction with the multi-chip module 1300 of FIG. 13.

Those skilled in the art will appreciate that the features of the present disclosure, as described above, can be used to provide multichip modules for use in wireless audio transmitters and receivers. The multi-chip modules may be configured to provide the following features and advantages, including creating portable wireless audio products that feature a dedicated wireless network, 24-bit uncompressed HD audio, ranges up to 500 feet, and point-to-multi-point transmission (i.e., one transmitter to multiple speakers, receivers, headphones, etc.).

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

The logical operations, functions, or steps described herein as part of a method, process or routine may be implemented (1) as a sequence of processor-implemented acts, software modules, or portions of code running on a controller or computing system and/or (2) as interconnected machine logic circuits or circuit modules within the controller or computing system. The implementation is a matter of choice dependent on the performance and other requirements of the system. Alternate implementations are included in which operations, functions or steps may not be included or executed at all, may be executed out of order from that shown or discussed, including substantially concurrently or in reverse order, depending on the functionality involved, as would be understood by those reasonably skilled in the art of the present disclosure.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

What is claimed is:

1. A multi-chip module for a high-fidelity wireless audio system, comprising:
a digital audio input;
a radio SoC;
an RF range extender; and
an antenna port.

2. The multi-chip module of claim 1, further comprising;
a boot loader for loading configuration information at startup,
a memory for storing the configuration information; and
selecting logic for indicating which configuration information should be loaded.

3. The multi-chip module of claim 1, further comprising:
a wireless module; and
an antenna control circuit for selecting between a proprietary wireless audio signal and a Wi-Fi signal.

4. The multi-chip module of claim 3, further comprising;
a boot loader for loading configuration information at startup,
a memory for storing the configuration information; and
selecting logic for indicating which configuration information should be loaded.

5. The multi-chip module of claim 1, wherein the digital audio input is an I2S audio input.

6. The multi-chip module of claim 1, wherein the digital audio input is a USB audio input.

7. A mutli-chip module for a high-fidelity wireless audio system, comprising:
a digital audio input;
a radio SoC;
an RF range extender;
an antenna switch; and
a plurality of antenna ports connected to the antenna switch.

8. The multi-chip module of claim 7, further comprising;
a boot loader for loading configuration information at startup,
a memory for storing the configuration information; and
selecting logic for indicating which configuration information should be loaded.

9. A multi-chip module for a high-fidelity wireless audio system, comprising:
an analog audio input;
a digital audio input;
an audio codec for converting an analog audio input to a digital signal;
a radio SoC;
an RF range extender; and
an antenna port.

10. The multi-chip module of claim 9, further comprising;
a boot loader for loading configuration information at startup,
a memory for storing the configuration information; and
selecting logic for indicating which configuration information should be loaded.

11. The multi-chip module of claim 9, further comprising:
a wireless module; and
an antenna control circuit for selecting between a proprietary wireless audio signal and a Wi-Fi signal.

12. The multi-chip module of claim 11, further comprising:
a boot loader for loading configuration information at startup,
a memory for storing the configuration information; and
selecting logic for indicating which configuration information should be loaded.

13. The multi-chip module of claim 9, further comprising:
an antenna switch; and
a plurality of antenna ports connected to the antenna switch.

14. The multi-chip module of claim 13, further comprising:
a boot loader for loading configuration information at startup,
a memory for storing the configuration information; and
selecting logic for indicating which configuration information should be loaded.

15. The multi-chip module of claim 9, wherein the digital audio input is an I2S audio input.

16. The multi-chip module of claim 9, wherein the digital audio input is a USB audio input.
